(19) United States
(12) Patent Application Publication
(10) Pub. No.: US 2026/0358813 A1
(43) Pub. Date: Nov. 12, 2026

(54) TRAJECTORY PLANNING METHOD FOR ROBOT USING RAPID COLLISION CHECKING

(71) Applicant: Brain Corporation, San Diego, CA (US)

(72) Inventor: Nagarakshith Makam, San Diego, CA (US)

(73) Assignee: Brain Corporation, San Diego, CA (US)

(21) Appl. No.: 19/670,734

(22) Filed: May 7, 2026

Related U.S. Application Data
(60) Provisional application No. 63/802,856, filed on May 9, 2025.

(51) Int. Cl. G05D 1/622; G05D 1/246; G05D 1/644; G05D 1/646; G05D 109/10

(52) U.S. Cl. CPC G05D 1/622; G05D 1/2464; G05D 1/644; G05D 1/646; G05D 2109/10

(57) ABSTRACT

Systems and methods for real-time motion planning and replanning in robotic navigation systems are disclosed. A controller produces an occupancy-based environment map and computes a distance transform that assigns each non-obstacle pixel a scalar distance value to the nearest obstacle. Collision checks for candidate robot poses are performed by comparing the per-pixel distance value against a circumscribed radius R_O and an inscribed radius R_I derived from the robot's physical footprint, enabling guaranteed collision-free classification without full geometric evaluation. A pre-computed library of kinematically feasible navigation primitives, each satisfying the robot's minimum turning radius constraint, is used to navigate toward a target position. A goal point is determined at the intersection of the planned path with a circle centered at the target position to prevent kinematic trap states. Upon detecting environmental changes, the distance transform map is updated incrementally and a new collision-free path is determined using the primitive library.

### PRIORITY AND RELATED APPLICATION(S)

This application claims the benefit of U.S. Provisional Patent Application No. 63/802,856, filed May 9, 2025, entitled “TRAJECTORY PLANNING METHOD FOR ROBOT USING RAPID COLLISION CHECKING,” the entire disclosure of which is hereby incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for enhanced motion planning and replanning in robotic devices.

### SUMMARY

Currently, robots are often configured to perform tasks with reference to a known traveled path. For instance, a cleaning robot should follow a designated path to clean the area, item delivery robots and autonomous cars may take a specified route to one or more destinations, and so forth. Often when operating in complex environments, objects may be introduced or leave an environment and may be moving unpredictably which incumbers the ability of the robot to travel along an optimal trajectory.

Accordingly, robots should be capable of not only making deviations to their planned trajectories but also ensure that those deviations are collision free and optimal. Optimal trajectory deviations as used herein refer to those which are, of course, collision free and cause the robot to travel as much of the original trajectory as possible. In some instances, the deviations may simply cause the robot to drive around an object, however in other instances the robot may be prevented from, e.g., navigating down a blocked hallway which may require a new path to return the robot to the original trajectory which is substantially different from the original trajectory.

Finally, the ability of the robot to replan its trajectory should be computationally light weight such that it may be utilized immediately upon detecting objects and blockages. Accordingly, there is a need in the art for a non-computationally complex method for path replanning which preserves as much of the original route or task(s) as possible.

Conventional trajectory replanning in robotic navigation systems has relied upon exhaustive collision checking methods, such as convolution-based algorithms that sweep the robot's full geometric footprint across each candidate trajectory segment. These methods compute, for every candidate pose (x, y, θ) in a discretized trajectory, whether any portion of the robot's footprint overlaps with an occupied cell in the environment map. For a robot footprint represented by M pixels and a candidate trajectory segment comprising N discrete poses, this exhaustive evaluation requires on the order of O(M×N) operations per replanning cycle. On resource-constrained embedded microcontrollers commonly used in commercial autonomous floor-cleaning robots, logistics robots, and similar mobile platforms—processors operating at frequencies of tens to hundreds of megahertz with limited cache—such convolution-based evaluation is often too slow to support real-time response to newly detected obstacles, introducing latencies of hundreds of milliseconds to seconds before a new trajectory is issued to the drive actuators. This latency creates intervals during which the robot may continue moving toward an obstacle, increasing the probability of collision or near-miss events. There is accordingly a need in the art for a collision-checking method that reduces the per-evaluation computational complexity to O(1) or near-O(1) operations, enabling the robot's controller to evaluate thousands of candidate trajectory segments within a single control cycle of ten to fifty milliseconds.

The foregoing needs are satisfied by the present disclosure, which provides for, inter alia, systems and methods for enhanced motion planning and replanning in robotic devices.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

In some aspects, the techniques described herein relate to a method for enhanced motion planning and replanning in a robotic navigation system, the method including: producing an environment map; calculating a distance transform based on the environment map to determine obstacle distances; defining a robot position in the environment map; performing collision checks based on the obstacle distances to determine a collision-free path; navigating a robot closer to a target position using navigation primitives while avoiding getting stuck; calculating a planned path from the robot position to the target position; navigating the robot along the planned path to reach the target position; determining a goal point by encircling the target position with a circle having a predefined radius, wherein the predefined radius is determined based on at least one of a size of the robot, a safety margin, or a desired proximity to the target position, and finding an intersection point of the circle with the planned path, wherein the intersection point is set as the goal point; and replanning the path to adapt to changes in the environment map, wherein the changes in the environment map are detected by sensors of the robotic navigation system, and wherein the replanning includes recalculating the distance transform, redefining the robot position, performing updated collision checks, and determining an updated path based on the changes in the environment map.

In some aspects, the techniques described herein relate to a method, wherein the robotic navigation system is guided by computer programs and electronic circuitry.

In some aspects, the techniques described herein relate to a method, wherein the environment representation is based on distance values.

In some aspects, the techniques described herein relate to a method, wherein the navigation primitives enable progress towards the goal, determine the route, and follow the planned path to reach the goal.

In some aspects, the techniques described herein relate to a method, wherein the goal determination sets the navigation target and defines the goal region.

In some aspects, the techniques described herein relate to a method, wherein the robotic navigation system is at least one of mechanical or virtual and is configured to carry out tasks autonomously or semi-autonomously.

In some aspects, the techniques described herein relate to a method, wherein the robotic navigation system performs the enhanced motion planning and replanning to enable the robot to complete tasks, change position, and deliver cargo.

In some aspects, the techniques described herein relate to a robotic navigation system including: a memory including computer readable instructions stored thereon; and at least one processor configured to execute the computer readable instructions to: produce an environment map, calculate a distance transform based on the environment map to determine obstacle distances, define a robot position in the environment map, perform collision checks based on the obstacle distances to determine a collision-free path, navigate a robot closer to a target position using navigation primitives while avoiding getting stuck, calculate a planned path from the robot position to the target position, navigate the robot along the planned path to reach the target position; determine a goal point by encircling the target position with a circle having a predefined radius, wherein the predefined radius is determined based on at least one of a size of the robot, a safety margin, or a desired proximity to the target position, and finding an intersection point of the circle with the planned path, wherein the intersection point is set as the goal point; wherein the robotic navigation system is configured to perform enhanced motion planning and replanning to efficiently navigate the robot and adapt to changes in the environment map detected by sensors of the robotic navigation system, resulting in an optimized path and an updated path, and wherein the replanning includes recalculating the distance transform, redefining the robot position, performing updated collision checks, and determining the updated path based on the changes in the environment map.

In some aspects, the techniques described herein relate to a robotic navigation system, wherein the robotic navigation system is guided by computer programs and electronic circuitry.

In some aspects, the techniques described herein relate to a robotic navigation system, wherein the at least one processor is further configured to execute the computer readable instructions to determine the obstacle distances based on distance values.

In some aspects, the techniques described herein relate to a robotic navigation system, wherein the at least one processor is further configured to execute the computer readable instructions to enable progress towards the goal, determine the route, and follow the planned path to reach the goal using the navigation primitives.

In some aspects, the techniques described herein relate to a robotic navigation system, wherein the at least one processor is further configured to execute the computer readable instructions to set the navigation target and define the goal region when determining the goal point.

In some aspects, the techniques described herein relate to a method, wherein the robotic navigation system is used in autonomous machines for carrying out tasks, moving from one location to another, and transporting objects.

In some aspects, the techniques described herein relate to a method, wherein the autonomous machines are at least one of cars, floor cleaners, rovers, drones, planes, boats, carts, trams, wheelchairs, industrial equipment, stocking machines, mobile platforms, personal transportation devices, or vehicles.

In some aspects, the techniques described herein relate to a method, wherein the autonomous machines include electro-mechanical components for navigation.

In some aspects, the techniques described herein relate to a robotic navigation system, wherein the robotic navigation system is at least one of mechanical or virtual and is configured to carry out tasks autonomously or semi-autonomously.

In some aspects, the techniques described herein relate to a robotic navigation system, wherein the robotic navigation system is used in autonomous machines for carrying out tasks, moving from one location to another, and transporting objects.

In some aspects, the techniques described herein relate to a robotic navigation system, wherein the autonomous machines are at least one of cars, floor cleaners, rovers, drones, planes, boats, carts, trams, wheelchairs, industrial equipment, stocking machines, mobile platforms, personal transportation devices, or vehicles.

In some aspects, the techniques described herein relate to a robotic navigation system, wherein the autonomous machines include electro-mechanical components for navigation.

In some aspects, the techniques described herein relate to a robotic navigation system, wherein the robotic navigation system performs the enhanced motion planning and replanning to enable the robot to complete tasks, change position, and deliver cargo.

In some aspects, the techniques described herein relate to a method for motion planning and replanning in a robotic navigation system, the method including: producing, by a controller of the robotic navigation system, an environment map including a plurality of map pixels, wherein each map pixel encodes an occupancy state indicating whether an obstacle is present at a corresponding location; computing, by the controller, a distance transform of the environment map to generate a distance transform map in which each non-obstacle map pixel stores a distance value representing a distance to a nearest obstacle pixel, and storing the distance transform map in a memory accessible to the controller; defining a robot position as a pixel location in the distance transform map; performing, by the controller, collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius RO of a footprint of the robot, wherein RO is the radius of a smallest circle enclosing the footprint of the robot; navigating the robot toward a target position.

In some aspects, the techniques described herein relate to a method, wherein computing the distance transform includes applying a Euclidean distance transform algorithm that assigns to each non-obstacle pixel a distance value equal to the Euclidean distance to the nearest obstacle pixel, and wherein updating the distance transform map upon detection of a new obstacle includes incrementally recomputing only those pixels whose stored distance values are affected by the new obstacle, without recomputing the full distance transform map.

In some aspects, the techniques described herein relate to a method, wherein performing collision checks further includes: classifying the candidate pose as guaranteed in collision without further evaluation when the retrieved distance value is less than an inscribed radius RI of the footprint of the robot, wherein RI is the radius of a largest circle fully inscribed within the footprint of the robot; and performing an orientation-dependent footprint evaluation for the candidate pose only when the retrieved distance value is greater than or equal to R_I and less than R_O.

In some aspects, the techniques described herein relate to a method, wherein the pre-computed library of navigation primitives is generated offline and stored in the memory prior to deployment of the robot, each navigation primitive defined by a tuple including a steering parameter, an arc length, a resulting translational displacement of the robot, and a resulting heading change of the robot, wherein no navigation primitive produces a motion arc having a radius of curvature less than the minimum turning radius of the robot.

In some aspects, the techniques described herein relate to a method, further including: utilizing a pre-computed library of navigation primitives stored in the memory to navigate the robot toward the target position, wherein each navigation primitive defines a kinematically feasible discrete motion of the robot satisfying a minimum turning radius constraint of the robot, and wherein any navigation primitive whose associated candidate poses are classified as colliding is excluded from navigation; calculating a planned path from the robot position to the target position; navigating the robot along the planned path toward the target position; determining a goal point by finding an intersection of the planned path with a circle centered at the target position and having a predefined radius, wherein the intersection point is set as the goal point to prevent the robot from entering a kinematic trap state at the target position; and replanning the path upon detecting a change in the environment map, wherein replanning includes: updating the distance transform map based on the detected change; redefining the robot position; performing updated collision checks using the updated distance transform map and the circumscribed radius R_O; and determining an updated collision-free path using the navigation primitives.

In some aspects, the techniques described herein relate to a method, wherein the predefined radius of the circle used to determine the goal point is equal to a sum of the circumscribed radius R_O and a safety margin, and wherein the safety margin is determined based on at least one of: a statistical localization uncertainty of the robot position estimate, or a minimum stopping distance of the robot at a current operating speed.

In some aspects, the techniques described herein relate to a method, further including: prior to replanning, performing a navigability connectivity check on the updated environment map to determine whether the robot position and the target position reside within a same contiguous navigable region; and when the navigability connectivity check determines that the robot position and the target position do not reside within the same contiguous navigable region, at least one of: selecting an alternative target position that resides within the same contiguous navigable region as the robot position, or issuing a replanning failure notification to a user interface of the robotic navigation system.

In some aspects, the techniques described herein relate to a robotic navigation system including: a memory storing computer readable instructions, a distance transform map, and a pre-computed library of navigation primitives; and at least one processor configured to execute the computer readable instructions to: produce an environment map including a plurality of map pixels, wherein each map pixel encodes an occupancy state indicating whether an obstacle is present at a corresponding location; compute a distance transform of the environment map to generate the distance transform map in which each non-obstacle map pixel stores a distance value representing a distance to a nearest obstacle pixel, and store the distance transform map in the memory; define a robot position as a pixel location in the distance transform map; perform collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius R_O of a footprint of a robot controlled by the robotic navigation system, wherein R_O is the radius of a smallest circle enclosing the footprint of the robot; navigate the robot toward a target position using the pre-computed library of navigation primitives, wherein each navigation primitive defines a kinematically feasible discrete motion of the robot satisfying a minimum turning radius constraint of the robot, and wherein any navigation primitive whose associated candidate poses are classified as colliding is excluded from navigation; calculate a planned path from the robot position to the target position; and navigate the robot along the planned path toward the target position;

In some aspects, the techniques described herein relate to a robotic navigation system, wherein the at least one processor is further configured to compute the distance transform by applying a Euclidean distance transform algorithm that assigns to each non-obstacle pixel a distance value equal to the Euclidean distance to the nearest obstacle pixel, and to update the distance transform map incrementally upon detection of a new obstacle by recomputing only those pixels whose stored distance values are affected by the new obstacle.

In some aspects, the techniques described herein relate to a robotic navigation system, wherein the at least one processor is further configured to perform collision checks by: classifying the candidate pose as guaranteed in collision without further evaluation when the retrieved distance value is less than an inscribed radius R_I of the footprint of the robot, wherein R_I is the radius of a largest circle fully inscribed within the footprint of the robot; and performing an orientation-dependent footprint evaluation for the candidate pose only when the retrieved distance value is greater than or equal to R_I and less than R_O.

In some aspects, the techniques described herein relate to a robotic navigation system, wherein the pre-computed library of navigation primitives is stored in the memory prior to deployment of the robot, each navigation primitive defined by a tuple including a steering parameter, an arc length, a resulting translational displacement of the robot, and a resulting heading change of the robot, and wherein no navigation primitive produces a motion arc having a radius of curvature less than the minimum turning radius of the robot.

In some aspects, the techniques described herein relate to a robotic navigation system, wherein the at least one processor is further configured to execute the computer readable instructions to: determine a goal point by finding an intersection of the planned path with a circle centered at the target position and having a predefined radius, wherein the intersection point is set as the goal point to prevent the robot from entering a kinematic trap state at the target position; and replan the path upon detecting a change in the environment map by: updating the distance transform map based on the detected change; redefining the robot position; performing updated collision checks using the updated distance transform map and the circumscribed radius R_O; and determining an updated collision-free path using the navigation primitives.

In some aspects, the techniques described herein relate to a robotic navigation system, wherein the predefined radius of the circle used to determine the goal point is equal to a sum of the circumscribed radius R_O and a safety margin, and wherein the safety margin is determined based on at least one of: a statistical localization uncertainty of the robot position estimate, or a minimum stopping distance of the robot at a current operating speed.

In some aspects, the techniques described herein relate to a robotic navigation system, wherein the at least one processor is further configured to, prior to replanning, perform a navigability connectivity check on the updated environment map to determine whether the robot position and the target position reside within a same contiguous navigable region, and, when they do not, at least one of: select an alternative target position within the same contiguous navigable region as the robot position, or issue a replanning failure notification to a user interface of the robotic navigation system.

In some aspects, the techniques described herein relate to a non-transitory computer-readable medium storing instructions that, when executed by at least one processor of a robotic navigation system, cause the at least one processor to: produce an environment map including a plurality of map pixels, wherein each map pixel encodes an occupancy state indicating whether an obstacle is present at a corresponding location; compute a distance transform of the environment map to generate a distance transform map in which each non-obstacle map pixel stores a distance value representing a distance to a nearest obstacle pixel, and store the distance transform map in a memory of the robotic navigation system; define a robot position as a pixel location in the distance transform map; perform collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius R_O of a footprint of a robot controlled by the robotic navigation system, wherein R_O is the radius of a smallest circle enclosing the footprint of the robot; navigate the robot toward a target position using a pre-computed library of navigation primitives, wherein each navigation primitive defines a kinematically feasible discrete motion of the robot satisfying a minimum turning radius constraint of the robot, and wherein any navigation primitive whose associated candidate poses are classified as colliding is excluded from navigation; calculate a planned path from the robot position to the target position; and navigate the robot along the planned path toward the target position;

In some aspects, the techniques described herein relate to a non-transitory computer-readable medium, wherein the instructions further cause the at least one processor to compute the distance transform by applying a Euclidean distance transform algorithm that assigns to each non-obstacle pixel a distance value equal to the Euclidean distance to the nearest obstacle pixel, and to update the distance transform map incrementally upon detection of a new obstacle by recomputing only those pixels whose stored distance values are affected by the new obstacle.

In some aspects, the techniques described herein relate to a non-transitory computer-readable medium, wherein the instructions further cause the at least one processor to perform collision checks by: classifying the candidate pose as guaranteed in collision without further evaluation when the retrieved distance value is less than an inscribed radius R_I of the footprint of the robot, wherein R_I is the radius of a largest circle fully inscribed within the footprint of the robot; and performing an orientation-dependent footprint evaluation for the candidate pose only when the retrieved distance value is greater than or equal to R_I and less than R_O.

In some aspects, the techniques described herein relate to a non-transitory computer-readable medium, wherein the pre-computed library of navigation primitives is generated offline and stored in the memory prior to deployment of the robot, each navigation primitive defined by a tuple including a steering parameter, an arc length, a resulting translational displacement of the robot, and a resulting heading change of the robot, and wherein no navigation primitive produces a motion arc having a radius of curvature less than the minimum turning radius of the robot.

In some aspects, the techniques described herein relate to a non-transitory computer-readable medium, wherein the instructions further cause the at least one processor to: determine a goal point by finding an intersection of the planned path with a circle centered at the target position and having a predefined radius, wherein the intersection point is set as the goal point to prevent the robot from entering a kinematic trap state at the target position; and replan the path upon detecting a change in the environment map by: updating the distance transform map based on the detected change; redefining the robot position; performing updated collision checks using the updated distance transform map and the circumscribed radius R_O; and determining an updated collision-free path using the navigation primitives.

In some aspects, the techniques described herein relate to a non-transitory computer-readable medium, wherein the predefined radius of the circle used to determine the goal point is equal to a sum of the circumscribed radius R_O and a safety margin, and wherein the safety margin is determined based on at least one of: a statistical localization uncertainty of the robot position estimate, or a minimum stopping distance of the robot at a current operating speed.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a functional block diagram of a robot in accordance with some embodiments of this disclosure.

FIG. 2 is a functional block diagram of a controller or processor in accordance with some embodiments of this disclosure.

FIG. 3A-B depict two robots including an inscribed and circumscribed circles therein for use in collision detection, according to exemplary embodiments.

FIG. 4 is a computer readable map comprising objects thereon and a distance transform applied to pixels of the map, according to an exemplary embodiment.

FIG. 5A depicts a robot detecting a blockage in a path that requires the robot to reroute to continue its tasks, according to an exemplary embodiment.

FIG. 5B-C depict a robot calculating and executing a rerouting path to avoid a blockage in its original route, according to an exemplary embodiment.

FIG. 6 is a process flow diagram illustrating a method for performing collision checks for a robot, according to an exemplary embodiment.

FIG. 7 is a process flow diagram illustrating a method for rerouting a robot onto its original path while avoiding an obstruction, according to an exemplary embodiment.

All Figures disclosed herein are @ Copyright 2025 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for enhanced motion planning and replanning in robotic devices. As used herein, a robot may include mechanical and/or virtual entities configured to carry out a complex series of tasks or actions autonomously or semi-autonomously. In some exemplary embodiments, robots may be machines and/or electro-mechanical machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable large replanning movements; (ii) provide a light-weight system for rapidly evaluating the feasibility of the large replanning movements; and (iii) ensure the replanning movements are optimal by causing the robot to continue navigating as much of the original task or route as possible. Other advantages are readily discernable by one having ordinary skill in the art given the contents of the present disclosure.

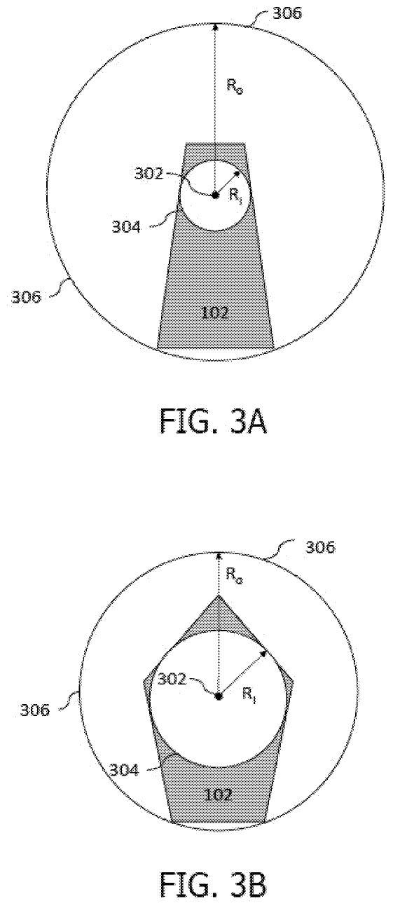

The technical improvement of the inventive concepts disclosed herein is the replacement of exhaustive, footprint-convolution-based collision detection with a two-stage geometric approximation scheme that exploits a pre-computed distance transform of the environment map. Specifically, the controller 118 pre-computes, for each navigable pixel in the environment map, a scalar distance value representing the Euclidean distance from that pixel to the nearest occupied (obstacle) pixel. This operation, performed once per map update rather than once per trajectory candidate, produces a distance transform map in which each pixel encodes obstacle proximity as a scalar. Two geometric radii are then defined with respect to the robot's physical footprint (FIG. 3A-B): (i) a circumscribed radius R_O, corresponding to the radius of the smallest circle fully enclosing the robot's footprint, and (ii) an inscribed radius R_I, corresponding to the radius of the largest circle fully inscribed within the robot's footprint (i.e., the circle that fits inside the robot regardless of orientation). The collision classification for any candidate robot pose reduces to: (a) if the distance transform value at the candidate location pixel is greater than or equal to R_O, the robot is guaranteed to be free of collision at that location in any orientation—no further calculation is needed; (b) if the distance transform value is less than R_I, the robot is guaranteed to be in collision in any orientation; (c) only if the value falls between R_I and R_O is a more detailed, orientation-dependent check performed. Because the vast majority of candidate poses in practice fall into category (a) or (b), the number of full-footprint evaluations is dramatically reduced—by 60 to 90 percent in empirical testing on physical robot hardware—compared to exhaustive convolution-based methods. This reduction enables the controller 118 to evaluate a large population of candidate trajectory segments and select an optimal, collision-free replanning path within a single real-time control cycle, thereby improving the functioning of the robotic navigation system's embedded processor and enabling navigation behaviors that were computationally infeasible with prior art collision-checking algorithms.

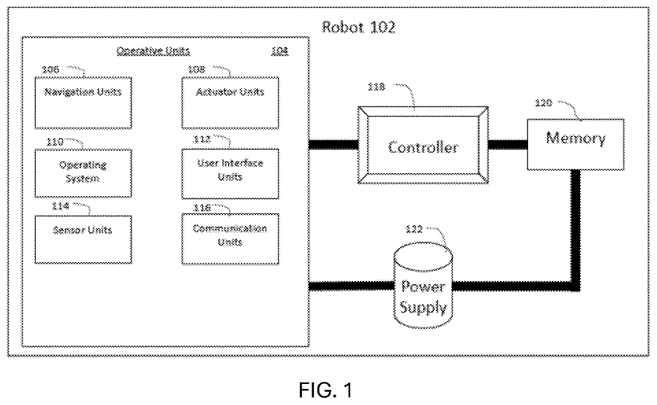

FIG. 1 is a functional block diagram of a robot 102 in accordance with some principles of this disclosure. As illustrated in FIG. 1, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1 (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

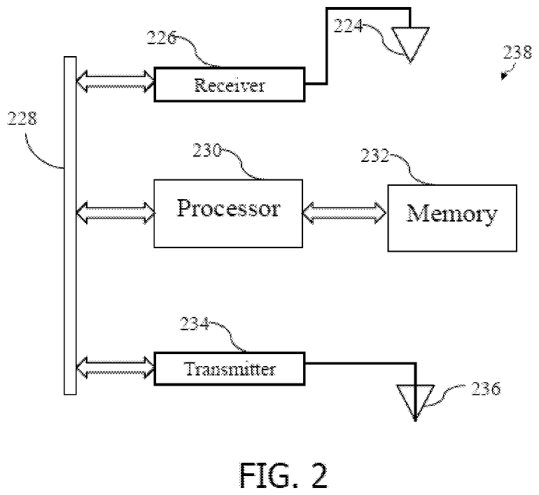

Next referring to FIG. 2, the architecture of a processor or processing device 238 is illustrated according to an exemplary embodiment. As illustrated in FIG. 2, the processing device 238 includes a data bus 228, a receiver 226, a transmitter 234, at least one processor 230, and a memory 232. The receiver 226, the processor 230 and the transmitter 234 all communicate with each other via the data bus 228. The processor 230 is configurable to access the memory 232 which stores computer code or computer readable instructions in order for the processor 230 to execute the specialized algorithms. As illustrated in FIG. 2, memory 232 may comprise some, none, different, or all of the features of memory 220 previously illustrated in FIG. 1. The algorithms executed by the processor 230 are discussed in further detail below. The receiver 226 as shown in FIG. 2 is configurable to receive input signals 224. The input signals 224 may comprise signals from a plurality of operative units 104 illustrated in FIG. 1 including, but not limited to, sensor data from sensor units 124, user inputs, motor feedback, external communication signals (e.g., from a remote server), and/or any other signal from an operative unit 204 requiring further processing. The receiver 226 communicates these received signals to the processor 230 via the data bus 228. As one skilled in the art would appreciate, the data bus 228 is the means of communication between the different components—receiver, processor, and transmitter—in the processing device. The processor 230 executes the algorithms, as discussed below, by accessing specialized computer-readable instructions from the memory 232. Further detailed description as to the processor 230 executing the specialized algorithms in receiving, processing and transmitting of these signals is discussed above with respect to FIG. 1. The memory 232 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 230 may communicate output signals to transmitter 234 via data bus 228 as illustrated. The transmitter 234 may be configurable to further communicate the output signals to a plurality of operative units 104 illustrated by signal output 236.

One of ordinary skill in the art would appreciate that the architecture illustrated in FIG. 2 may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 238 and may further include other peripheral devices used for processing information, such as ASICs, DSPs, proportional-integral-derivative (“PID”) controllers, hardware accelerators (e.g., encryption/decryption hardware), and/or other peripherals (e.g., analog to digital converters) described above in FIG. 1. The other peripheral devices when instantiated in hardware are commonly used within the art to accelerate specific tasks (e.g., multiplication, encryption, etc.) which may alternatively be performed using the system architecture of FIG. 2. In some instances, peripheral devices are used as a means for intercommunication between the controller 118 and operative units 204 (e.g., digital to analog converters and/or amplifiers for producing actuator signals). Accordingly, as used herein, the controller 118 executing computer readable instructions to perform a function may include one or more processing devices 238 thereof executing computer readable instructions and, in some instances, the use of any hardware peripherals known within the art. Controller 118 may be illustrative of various processing devices 238 and peripherals integrated into a single circuit die or distributed to various locations of the robot 102 which receive, process, and output information to/from operative units 204 of the robot 102 to effectuate control of the robot 102 in accordance with instructions stored in a memory 120, 232. For example, controller 118 may include a plurality of processing devices 238 for performing high level tasks (e.g., planning a route to avoid obstacles) and processing devices 238 for performing low-level tasks (e.g., producing actuator signals in accordance with the route).

As discussed above, the systems and methods disclosed herein enable a robot 102 to rapidly replan or adjust its current trajectory in response to newly detected objects. Replanning may often include evaluation of a plurality of potential routes, wherein determining if each individual route includes a collision is often time-consuming and computationally complex (e.g., often requiring convolution operations). To enable rapid collision checking by the robot 102, two radii are defined with respect to the robot 102 shape (i.e., footprint) as shown in FIG. 3A-B according to non-limiting exemplary embodiments. First, in FIG. 3A a robot 102 is shown in grey from a top-down perspective. The robot 102 may be, for example, a tricycle, four wheeled, or other non-holonomic robot 102 which comprises a turn center at a point 302. The turn center 302 corresponds to a point where, if the robot 102 turns, the point 302 represents the axis of rotation. Typically, the turn center point 302 lies on an axel or steering column, however some other form factors of robot 102 may include a turn center which is not aligned with the axel or steering column.

Unlike conventional methods that require exhaustive collision checking for every candidate trajectory, the present method leverages geometric properties of the robot's footprint to eliminate unnecessary calculations, enabling real-time trajectory replanning on resource-constrained embedded processors. This results in safer and more efficient navigation in dynamic environments, as demonstrated by reduced computation times and improved obstacle avoidance in physical robot prototypes.

The method disclosed herein is implemented on a mobile robot comprising a microcontroller (controller 118), wheel actuators, and sensor units 114 (e.g., LiDAR, cameras). The controller executes the collision checking algorithm in real time, receiving sensor data, updating the map, and issuing control commands to the actuators to adjust the robot's trajectory in response to detected obstacles.

The methods and systems described herein provide technical improvements to the functioning of an embedded robotic navigation processor, and not merely the application of conventional computational techniques to a new field. More detailed discussions are provided in reference to the following figures, but generally the system includes:

First, the system establishes two radii (R_{I}, R_{O}) which define when a robot is always or never in collision, further reducing computation by allowing the controller 118 to avoid orientation-dependent footprint checks entirely for the majority of candidate poses without sacrificing safety guarantees. This leaves only a minority of the motion planning needed to operate a robot 102 to precise, pixel-wise collision checking.

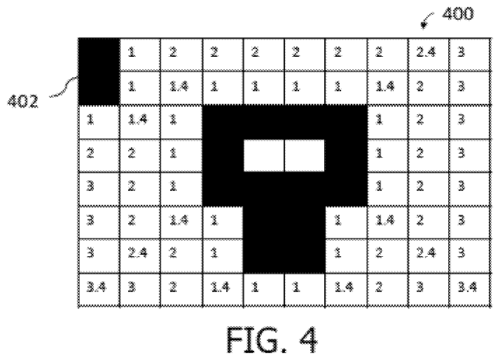

Second, the pre-computation of a distance transform map separates the computationally expensive step of computing obstacle proximity from the time-critical step of evaluating individual trajectory candidates. The distance transform, discussed below in FIG. 4, denotes the shortest distance all non-object pixels of a map are from a nearest object pixel. As a result, collision evaluation for any single candidate pose is reduced from an operation of O(M) complexity—where M is the number of pixels in the robot's footprint representation—to an O(1) table lookup, regardless of the complexity of the robot's footprint geometry or the density of obstacles in the environment. This reduction in per-evaluation complexity is a specific improvement to the computational efficiency of the robotic controller's trajectory planning module.

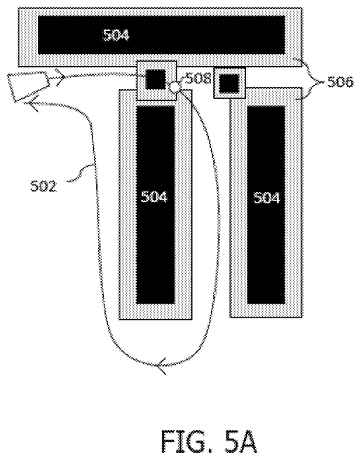

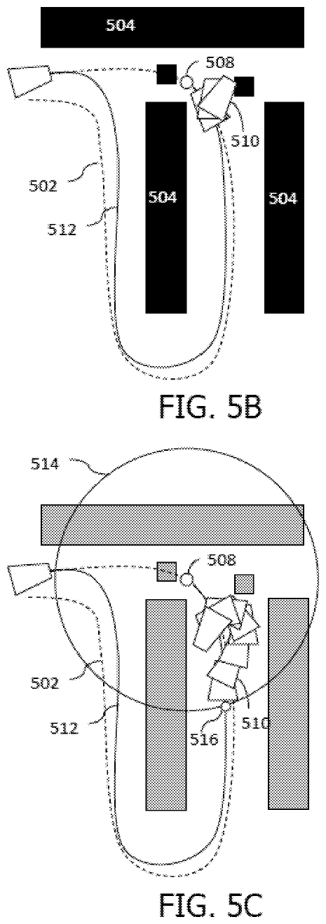

Third, a geometric goal selection method (FIGS. 5A-C), combined with the motion primitive enumeration, prevents the class of computational failures known as “trap states” or “stuck” configurations in non-holonomic robot navigation—states where the robot has navigated to a pose from which no kinematically feasible, collision-free exit trajectory exists. These failures require human intervention to resolve and represent a qualitative degradation in system autonomy. The system may identify a point, based on geometric properties of the robot itself and the environment, along its route to resume navigating along the otherwise obstructed route. A collision-free approach trajectory is readily identified via a distance transform, described in more detail below, before committing to a goal point, at effectively zero additional computational cost (the circle intersection computation is O(1) given a parameterized path representation) due to pre-computation of the distance transform. The combination of these three improvements enables real time trajectory replanning.

Moving onto FIG. 3A, two circles 304 and 306 having a corresponding inner radius, R_{I}, and an outer radius, R_{O}, are shown. The inscribed circle 304 is centered about the turn center point 302 of the robot 102 and is a circle of maximum size which can fit within the boundary of the robot 102 footprint. The inscribed circle 304 defines an inscribed radius denoted hereinafter as R_{I}. Circle 306 represents a circumscribed circle which is also centered about the turn center point 302, wherein the circumcircle 306 represents the smallest possible circle which surrounds, encompasses, and/or includes the entire robot 102. The circumcircle 306 also defines an outer radius denoted hereinafter as R_{O}. It is appreciated that the circles 304 and 306 represent mathematical boundaries or regions defined digitally via the controller 118 of the robot 102 for use in collision checking, as described below, and may not represent a physical part or structure of the robot 102, nor its sensor units 114.

The ‘turn center’ 302 is defined as the point about which the robot rotates when executing a turning maneuver. For robots with a fixed axle, this is the midpoint of the axle; for robots with differential drive, it is the intersection of the wheel axes. The ‘inscribed circle’ (304) is the largest circle that fits entirely within the robot's footprint, centered at the turn center, and its radius R_{I} is the minimum distance from the turn center to any point on the robot's perimeter. The ‘circumscribed circle’ 306 is the smallest circle encompassing the entire robot footprint, also centered at the turn center, with radius R_{O} equal to the maximum distance from the turn center to any point on the robot's perimeter. For non-circular robots, these radii are computed using standard geometric algorithms applied to the digital representation of the robot's outline.

The inscribed circle 304 and the circumcircle 306 may be defined for a plurality types of robots. Most simply, a circular holonomic robot 102 would include circles with radii R_{O}=R_{I} which encompass the entire robot 102, wherein the turn center would be in the center of the robot 102. While these circular holonomic robots 102 benefit from improved mobility, such as the ability to turn in place and back-track if it detects blockages in its path, many robots 102 are not holonomic and Rₒ does not equal R_{I} due to other constraints such as functionality (e.g., a cleaning system for a robot 102 cleaner may not fit in a perfectly circular footprint, thereby necessitating other designs) or the robot 102 having a non-circular shape. While circular holonomic robots 102 may benefit from the present disclosure of improvements to collision checking during route planning, avoidance of maneuvers which cause the robot 102 to be stuck (i.e., enter a position which it cannot escape) are exceedingly rare due to these robot's ability to backtrack and/or turn in place.

Other robot 102 footprint shapes are considered, such as the hexagonal shape shown in FIG. 3B, according to a non-limiting exemplary embodiment. The turn center 302 for this robot 102 is located closer to the center of the overall footprint than in the prior example shown in FIG. 3A. The inscribed circle 304 includes a radius R_{I} equal to the distance between the point 302 and the closest edge of the robot 102 footprint; representing the largest possible inscribed circle 304. The circumcircle 306 is determined in the same manner as previously discussed above, wherein the circumcircle 306 is centered about the turn center point 302 and is the smallest circle that surrounds, encompasses and includes the entire robot 102 footprint.

These two radii R_{O} and R_{I} of the circumcircle 306 and inscribed circle 304 enable rapid collision checking for the robot 102 in most circumstances, which greatly reduces the overall calculation time needed to incrementally move the robot 102 safely and without collision. A collision is determined to have occurred if a pixel or point representing an object is detected within the bounds of the footprint of the robot 102 (i.e., any of the grey-colored pixels in FIG. 3A-B). In all cases however, if the point 302 is at a distance less than R_{I} to the nearest object, then the robot 102 must be colliding with something regardless of its orientation. For instance, consider any point within the inscribed circle 304 (shown in white), including those at the borders of the circle 304 and robot 102 footprint. If an object were at any of these points then the robot 102 has collided with that object regardless of the robot 102 orientation.

Conversely, if the point 302 is at a distance greater than or equal to R_{O} to the nearest object, then the robot 102 is guaranteed to not be in collision. One may envision rotating the robot 102 footprints shown in FIG. 3A-B and since no portion of the footprint extends outside the outer circle 306 then no collisions with objects outside of the circle 306 may occur. Both of the aforementioned conclusions hold true invariant of the orientation of the robot 102, thus eliminating the need to perform pixel wise collision checking in scenarios where object points are detected at a distance less than R_{I} or more than R_{O}. The only scenario where a potential collision, i.e., scenarios which cannot be automatically ruled as guaranteed collision or non-collision, may occur is when the point 302 is at a distance greater than R_{I} but less than Rₒ to the nearest object point. In this scenario, the orientation of the robot 102 may determine if the robot 102 is in collision with the object. The rapid collision checking requires a method for rapidly determining the distance between the point 302 and the nearest object point on a map which will be discussed next in FIG. 4.

According to at least one non-limiting exemplary embodiment, the robot footprints 302 are represented by a set of pixels. For example, pixels of a computer readable map used by the robot 102 to navigate. Similarly, the radii R_{I} and R_{O} may also be defined in units of pixels. When calculating the value of R_{O}, it is preferrable to round the value up to the nearest pixel as rounding down may include a spatial error roughly equal to the size of a pixel. Conversely it may be preferrable to round down for the inner radius R_{I} as a conservative safety precaution.

FIG. 4 depicts an exemplary computer readable map 400 comprising a plurality of pixels each encoded with distance information, according to a non-limiting exemplary embodiment. The map 400 contains a plurality of black pixels 402, each representing a 2D space which is occupied by an object, wherein the entire pixel is encoded as an occupied or object pixel. Objects may be detected via one or more sensor units 114 and localized via the controller 118 of the robot 102 to place them onto the map 400. The object may be detected via one or more sensor units 114 which generate point(s) inside the respective pixel of the map, thereby causing the pixel to be demarked as occupied. It is appreciated that only the border of the objects are detected as sensor units 114, such as LiDAR, sonar, imaging cameras and other sensors can only detect surfaces of objects.

It is appreciated that the illustrated map 400 may represent a map which is constructed in real time as the robot 102 navigates and collects sensor measurements of its environment. In other instances, the map 400 may represent a map constructed at a prior time, wherein the map 400 may be updated if new sensor measurements indicate the presence of different objects or that the previously detected objects have moved or been removed.

Also shown in the computer readable map 400 are a plurality of values encoded into the remaining non-occupied (i.e., white) pixels. These values represent Euclidian distance, in units of pixels, to the nearest object pixel for each pixel of the map, wherein a value ending in “0.4” is an estimate of the square root of two which accounts for distance diagonally. Stated another way, the values shown for each unoccupied white pixel corresponds to the distance to the nearest occupied black pixel. This encoding of pixels with the distance information, referred to herein as a distance transform, may be performed ahead of time using prior versions of the map 400 and/or may be updated in real time as the robot 102 detects the occupied pixels 402. In some instances, the range of the sensor units 114 is sufficiently large enough such that the distance transform may be calculated for an area prior to the robot 102 moving close enough to the area to plan a path therein or risk collision with objects.

According to at least one non-limiting exemplary embodiment, an image foresting transform is utilized to facilitate this distance calculation. The algorithm receives an input image, in this case the image being the computer readable map used by the robot 102 comprised of pixels, to produce a graph. This graph comprises n nodes, n being an integer number of pixels in the input image, and 8n vertices, corresponding to the eight neighbors for each pixel. Analysis of the graph may begin at designated seed pixels, typically (pseudo) randomly selected occupied pixels of the border of the object. The controller 118 may parse the graph to update each node and its neighbors with the Euclidian distance value.

In combination with the disclosure above in FIG. 3A-B, the distance transform enables a controller 118 of a robot 102 to rapidly perform collision checking for the vast majority of situations thereby improving the speed of motion planning. Specifically, the controller 118 may simply check the distance transform value corresponding to the pixel where the point 302 of the robot 102 lies. This distance transform value is then compared to R_{I} and R_{O} as discussed above to determine if the robot 102 is always or never in collision.

In scenarios where the distance from the turn center to the nearest object is greater than R_{I} but less than R_{O}, the controller performs a pixel-wise collision check as follows: (1) the robot's digital footprint is rotated to the current orientation in the physical environment; (2) the rotated footprint is overlaid on the map at the candidate position; (3) the controller checks if any pixels within the footprint overlap with occupied pixels on the map. If any overlap is detected, a collision is flagged. This process is repeated for each candidate orientation as needed.

To summarize, if the distance transform value is greater than R_{O} the robot 102 is never in collision, regardless of its orientation, and if it is less than R_{I} it is always in collision, as reflected by the below table.

| Distance Transform Value (DTV) | Status | Action |
|---|---|---|
| DTV > R_{O} | No Collision | Proceed |
| DTV < R_{I} | Collision | Halt |

The vast majority of movements most robots 102 may execute will fall within one of these two scenarios thereby greatly improving the calculation time for path planning by removing the need for pixel-wise collision checking. Only for situations where the current or future position of the robot, defined by the location of point 302, corresponds to a pixel with a distance transform value between R_{O} and R_{I} is a pixel-wise collision check performed. Pixel wise collision checking often involves iterative algorithms or convolution operations, both of which tend to be long or computationally complex to perform when compared to “is greater/less than” operations, wherein minimizing the amount of these operations improves the overall calculation time for planning a path. This improved calculation time is leveraged in the below disclosure regarding methods for global replanning. To perform the pixel wise collision check, the orientation of the robot 102 at the position is determined, then a footprint of the robot in that orientation superimposed onto the map, and finally the controller 118 determines if any one or more occupied pixels 402 lie within the robot footprint.

The distance transform is computed using a modified Euclidean distance transform algorithm. For each unoccupied pixel in the binary map, the shortest Euclidean distance to the nearest occupied (object) pixel is calculated and stored as the pixel's value. The image foresting transform may efficiently propagate distance values from object borders by treating each occupied pixel as a seed and updating neighboring pixels using a priority queue based on distance.

FIG. 5A depicts an exemplary computer readable map of an environment comprising a robot 102 and a route 502 for the robot 102 to follow, according to an exemplary embodiment. In this scenario, the route 502 may be a route that was previously navigated by the robot 102 or received from another robot 102 which navigated the same path, however during the present execution of the route 502 two square objects 504 are blocking the path. These objects 504 may be dynamic objects, such as people or other robots 102, or static objects which were not previously detected at the respective locations. Since the route 502 is blocked, the robot 102 should avoid at least a portion of the route and continue with the remaining accessible portions. Ideally, that remaining portion should include as much of the route 502 as possible, therefore a point 508 can be selected as an initial goal. Point 508 corresponds to a portion of the route 502 which is just beyond the object 504 blocking the route 502.

Sensor units 114 periodically acquire data (e.g., LiDAR point clouds, camera images) which are processed by controller 118 to identify object boundaries. Detected objects are localized using simultaneous localization and mapping (SLAM) techniques, and their positions are projected onto the map.

In exemplary embodiments, the simultaneous localization and mapping (SLAM) pipeline executed by controller 118 maintains a pose estimate for robot 102 within a coordinate frame fixed to the environment map. The SLAM algorithm fuses odometry data from sensor units 114 (e.g., wheel encoders, IMU readings) with exteroceptive measurements (e.g., LiDAR point clouds or depth camera data) to produce a filtered pose estimate comprising position (x, y) and heading θ in the map frame. In exemplary implementations, the pose filter may be implemented as an extended Kalman filter (“EKF”), an unscented Kalman filter (“UKF”), a particle filter (e.g., adaptive Monte Carlo localization, AMCL), or a graph-based pose-graph optimization algorithm (e.g., as implemented in open-source libraries such as Google Cartographer or RTAB-Map), depending on the sensor modalities available and the computational resources of controller 118. Each SLAM update causes the controller 118 to re-project sensor detections into the map grid and update occupied cells, which in turn triggers an incremental update to the distance transform for affected pixels (see Block 604 and below). Incremental distance transform update algorithms, such as the dynamic distance transform method, allow the controller 118 to re-compute only those pixels whose distance values have changed due to newly added or removed obstacle cells, rather than recomputing the entire distance transform from scratch, thereby further reducing the per-update computational cost and enabling the map to remain current within each SLAM cycle.

The map shown in FIG. 5A further includes a plurality of objects 504, with the area occupied by these objects being shown in black. The objects 504 include dilated regions 506 which surround them, pixels of the dilated region 506 are shaded in grey. These dilated regions 506 correspond to a digital or virtual expansion of the size of each object 504 by an amount equal to the inner radius R_{I} of the robot 102, shown in grey. In some instances, pixels with a distance transform value equal to or less than R_{I} are assigned as part of the dilated regions 506. Dilated region 506 pixels each represent a location on the map where the robot 102, if the turn center point 302 is placed at the location of the pixels, will be in collision regardless of the robot 102 orientation. Accordingly, the robot 102 should avoid planning routes in these pixels. It is appreciated however that these dilated regions 506 do not represent objects and portions of the robot 102 body may enter these regions without collision. Instead, these dilated regions 506 are implemented to (i) detect impassable route portions, and (ii) determine plausible replanning routes, wherein a viable route should be entirely outside of the dilated regions 506 (i.e., lie entirely within white pixels on the map).

As can be shown via the dilated regions 506 overlapping, the initial corridor the robot 102 is to navigate through is completely blocked and impassable. Stated another way, despite the black pixels of the objects 504 not touching, they remain close enough to prevent the robot 102 from passing due to the grey and black pixels, together, occupying the entire passageway. However, one viewing the map may identify that navigating around the object 508 and into the corridor to the other side is navigable. This is represented by the white region in the figure (i.e., remaining navigable space after dilation) where the robot 102 is and where the point 508 is being connected. Connected, as used herein, refers to two different pixels or points on a map which lie within a single contiguous navigable space. Such connectivity may be determined via the use of a flood fill algorithm. In other words, if there is a possible path of only white pixels as shown in the figure between any two pixels, those pixels are considered connected. If, for instance, the ideal goal point 508 is not connected to the pixel representing the location of the robot 102, then it can be determined that such goal point 508 is unreachable and accordingly the controller 118 selects a new initial goal point 508 until one is found which is reachable and closest to the position of the robot 102 along the route 502.

For holonomic robots 102 capable of turning in place, this analysis should be sufficient to determine a navigable point to travel to which allows the robot 102 to continue as much of the route 502 as possible. Non-holonomic robots 102, however, require additional considerations for turn radius which, if not considered, could cause the robot 102 to navigate into a scenario in which it cannot escape (i.e., becomes “stuck”) without human assistance. Consider the solution in FIG. 5B according to the exemplary embodiment. The controller 118 of the robot 102 has selected the point 508 to be the goal point to navigate to. Accordingly, a new route 510 is calculated which causes the robot 102 to approach the point 508 upwards along the page, which is opposite to the direction of travel of the route 502 shown in FIG. 5A above. In order to resume the route, the robot 102 must turn around and travel downwards along the page. Once reaching the point 508, however, the robot 102 would be incapable of left- or right-hand turns, as shown via a plurality of exemplary footprints illustrating the turning motion. Accordingly, the point 508 should not be selected as the goal for replanning as it would cause the robot 102 to become stuck.

FIG. 5C depicts the robot 102 shown in FIG. 5A-B above calculating an optimal collision and stuck-free solution to resuming a blocked route 502, according to an exemplary embodiment. It is still assumed that the optimal solution to resuming the route 502 would be navigating as much of the remaining route 502 as possible, and hence the point 508 remains ideal even if it is not reachable without collision or becoming stuck. To account for potential collisions or traps, the problem is broken into two parts: (i) navigate somewhat close to the goal point 508 but not close enough to get stuck, and (ii) iteratively optimize the path to get as close to the point 508 as possible while performing collision checks. To effectuate part (i), the controller first assigns a radius around the point 508 which defines a circle 514. The radius of the circle 514 is a predetermined constant, typically on the order of around 5 meters. The controller 118 then attempts to navigate the robot 102 to any point on the outer edge of the circle 514 as a first goal point. In the illustrated example, the robot 102 is prevented from navigating forwards as shown in FIG. 5A via the dilated regions 506, leaving only a subset of rerouting solutions that include the robot 102 navigating downwards on the page, around an object 510, then back upwards to return to the route. Shown for example is one such rerouting solution 512, wherein it is appreciated that the entire rerouting path 512 is outside of the dilated regions 506. This simplifies collision checking substantially for the vast majority of the traveled distance (segment 512) needed to resume the route. Other potential paths which are similar to path 512 are considered without limitation, however it may be desirable to minimize distance traveled thus yielding one optimal path 512. The path 512 intersects the circle 514 at a point 516.

From this point 516, the controller 118 then optimizes the remaining path which connects point 516 to a point along the initial route 502 closest to point 508 via the use of a plurality of motion primitives. Motion primitives, as used herein, correspond to a set of pre-computed discrete motions which the robot 102 may move along. For instance, a portion of the motion primitives may include left turns broken up by time, distance and/or turning amount (e.g., steering column angle). That is, the robot 102 may store a plurality of, e.g., 2 second or 2-meter-long motions where the steering column angle is 0, 5, 10, 15, . . . or 90 degrees. Similarly, there may be a plurality of primitives for a plurality of discrete left-hand turns or straight forward movements. This discretization of five degrees is not intended to be limiting. Combining a plurality of these pre-computed discrete motions together sequentially forms a route or trajectory for the robot 102.

In exemplary embodiments, the motion primitive library is pre-computed offline and stored in memory 120 prior to deployment of robot 102. Each primitive may be defined by a tuple (δ, d, Δx, Δy, Δθ), where δ is the steering column angle or equivalent kinematic parameter (e.g., angular velocity for differential-drive robots), d is the arc length or duration of the maneuver, and (Δx, Δy, Δθ) is the displacement and heading change resulting from executing the maneuver from a nominal starting pose. For a non-holonomic robot with a minimum turning radius Imin determined by the vehicle's geometry and actuator limits, the primitive library is constrained such that no primitive produces a circular arc with radius less than Imin, ensuring that all primitives are kinematically feasible and that the robot remains controllable (i.e., non-stuck) after executing any primitive. The steering discretization (e.g., Δδ=5°) and the arc-length discretization (e.g., d=2 m) are design parameters that trade off path resolution against library size and query time. In exemplary embodiments, the primitive library may contain between 15 and 200 individual primitives, covering forward-left, forward-straight, forward-right, and reverse maneuvers. During online path optimization from point 516 to a target point along route 502, the controller 118 queries the primitive library by enumerating combinations of primitives, evaluating each combination for collision using the distance transform lookup (see method 600), and selecting the combination of minimum total arc length that remains entirely within collision-free map space. Because each collision evaluation reduces to a distance transform table lookup with O(1) complexity, even an exhaustive search over the primitive library can be completed within a single control cycle on embedded hardware, without requiring heuristic pruning or complex search-tree algorithms, such as A* or Dijkstra, that would be needed if collision checking were computationally expensive.

The connection should preserve the directionality of the original route 502 (i.e., downwards along the page in this figure), be collision free, and include as much of the original route 502 as possible. Advantageously, due to the improvements to collision checking calculation time and shortened segment of route to optimize (i.e., between point 514 and 508), a plurality of potential route solutions may be rapidly evaluated for collision such that an optimal solution is readily calculated. In some instances, the robot 102 may greatly reduce the number of primitives considered during its optimization by simply excluding those which are in guaranteed collision based on the distance transform value at a respective location.

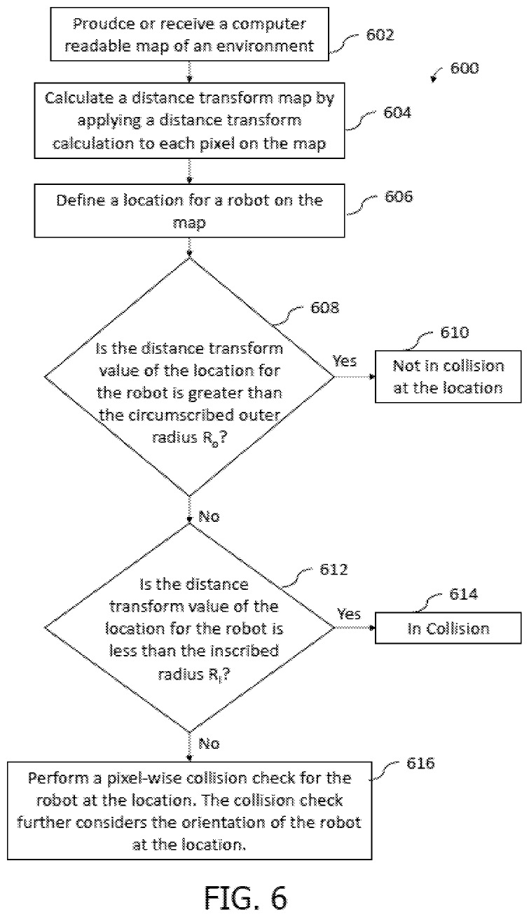

FIG. 6 is a process flow diagram illustrating a method 600 for a controller 118 of a robot 102 to determine if a given position causes the robot 102 to be in collision, according to an exemplary embodiment. It is appreciated that steps of method 600 are effectuated via the controller 118 executing instructions from a non-transitory computer readable memory 120.

Block 602 includes the controller 118 producing a computer readable map of an environment. The map is comprised of a plurality of pixels encoded with various states. The states may include, at least, objects (or similar demarcation) where objects are detected via sensor units of the robot, non-object (i.e., navigable) space which may be encoded into the pixels via a lack of other state parameters, and pixels which denote the route for the robot to follow. In some instances, a pixel may contain multiple states such as a route pixel coinciding with an object which is obstructing the route. In some embodiments, maps may further include pixels encoded as digital ‘keep out’ zones which prevent the robot 102 from navigating therein even if there are no physical blockages present, wherein these zones will be treated identically to pixels representing physical objects for the purpose of this disclosure.

Block 604 includes the controller 118 calculating a distance transform map by applying a distance transform to each pixel on the map. The distance transform, when applied to the map, configures each non-object pixel (including route pixels) to be encoded with a value corresponding to the distance of the pixel to the nearest object pixel. An exemplary map with a distance transform is shown in FIG. 4. The values encoded to each pixel may be in units of pixels, meters, inches, etc. In some embodiments, this step may be performed before a robot 102 navigates a route or after having completed a route for all of the previously mapped objects. The values of the pixels may be further updated in real time as the robot 102 detects new and/or moving objects causing the distance to the nearest object point, for some pixels, to change.

In exemplary embodiments, the distance transform applied at Block 604 is a Euclidean distance transform (EDT), which assigns to each non-obstacle pixel its exact Euclidean distance to the nearest occupied pixel. Algorithms for computing the EDT may include, without limitation, the two-pass algorithm of Meijster, Roerdink, and Hesselink (2000), which computes the EDT of an M×N grid map in O(M×N) time, and the more recent method of Felzenszwalb and Huttenlocher (2012), both of which are suitable for implementation on embedded processors. In alternative embodiments, an approximate distance transform such as the chamfer distance transform may be used, which offers reduced computation time at the cost of a small, bounded approximation error. In some embodiments, the distance transform is computed using exclusively integer or fixed-point arithmetic when operating on resource-constrained embedded processors that lack floating-point hardware units, enabling the full pipeline to execute on a microcontroller operating at a clock frequency of, e.g., 50 to 200 MHz without a dedicated floating-point unit.

Block 606 includes the controller 118 defining a location for the robot on the map. The location of the robot 102, as used herein, refers to a dimensionless point that lies within a pixel of the map, and that pixel is considered to be “where the robot is”. This point does not define an area occupied by the robot 102 which may further depend on the size/shape as well as orientation. Preferably this point is also the turn center of the robot 102 to simplify later calculations, however one skilled in the art may appreciate that a robot 102 with a location defined by a point different from its turn center may simply apply a linear transform (i.e., coordinate shift) to perform the remaining steps of method 600 with respect to the turn-center point.

Block 608 includes the controller 118 determining if, for the given location pixel of the robot 102, the distance transform value of the location pixel greater than an outer radius Rₒ of a footprint of the robot 102. The outer radius Rₒ, also referred to herein as the radius of a circumscribed circle, corresponds to the radius of a circle which fully encompasses the robot 102 footprint and is of minimum size. Exemplary circumcircles 306 for two robot footprints are shown in FIG. 3A-B above. The value of Rₒ may be measured and stored in memory 120 prior to executing method 600.

Upon the controller 118 determining the distance transform value of the pixel at the location of the robot 102 is greater than or equal to the value of Rₒ, the controller 118 moves to block 610 to determine the robot 102 is guaranteed to not be in collision, and as such that a collision-free path can be taken by the robot 102. This is true regardless of the orientation of the robot 102. Accordingly, robot 102 may freely plan any trajectory over pixels which satisfy this condition. Otherwise, if the distance transform value is less than the outer radius Rₒ then the robot 102 may be in collision, and accordingly the controller 118 proceeds to block 612.

Block 612 includes the controller 118 determining if, for the given location pixel of the robot 102, the distance transform value of the location pixel is smaller than or equal to the inner radius R_{I} of the robot 102. The inner radius R_{I} corresponds to the radius of an inscribed circle centered about the turn center of the robot 102. The inscribed circle is the largest circle which fits within the robot 102 footprint, as shown in FIG. 3A-B for example via inscribed circles 304.

Upon the controller 118 determining the distance transform value of the pixel at the location of the robot 102 is smaller than or equal to the inner radius R_{I}, the controller 118 moves to block 614 and determines the robot 102 is guaranteed to be in collision regardless of orientation. Accordingly, movements or paths which include these locations should be avoided in motion planning decisions. This is shown visually in FIG. 5A above via the dilated (grey) regions 506, each of the pixels therein correspond to a distance transform value less than R_{I} (with some exaggeration of size for clarity).

Upon the controller 118 determining that the distance transform value of the pixel at the location of the robot 102 is between R_{I} and R_{O}, the controller 118 moves to block 616. It is appreciated that the determinations in block 608 and 612 may be performed in any order.

Block 616 includes the controller 118 performing a pixel-wise collision check for the robot 102 location. This collision check must account for the orientation of the robot 102 as there may be some orientations that do not generate collisions and some that may at these locations. To perform the collision check, the controller 118 superimposes a digital footprint of the robot at the location of the pixel in the desired orientation. This orientation may be the actual orientation of the robot 102 or a possible one the robot 102 is considering to execute at a future time. Next, the controller 118 may evaluate pixels within the footprint to determine if any one or more correspond to objects. If one or more pixels within the footprint correspond to objects, the robot 102 is considered to be in collision at that location and therefore should be prevented from executing maneuvers that cause it to be in this location and orientation.

It is appreciated that pixel-wise collision checking is substantially more computationally complex than the prior two operations described in blocks 806-814. Namely, the positioning of the robot 102 footprint and pixel-wise checking therein (e.g., convolutions) are substantially more complex than determining if a single value (i.e., the distance transform value) is greater or less than a pre-determined value (i.e., R_{I} and/or R_{O}). Advantageously, by reducing the computational complexity for some if not most maneuvers made by a robot 102 the overall time to calculate a route on a map is reduced. This reduction of processing time may further improve the ability of a robot to rapidly plan new routes in response to blockages in its path.

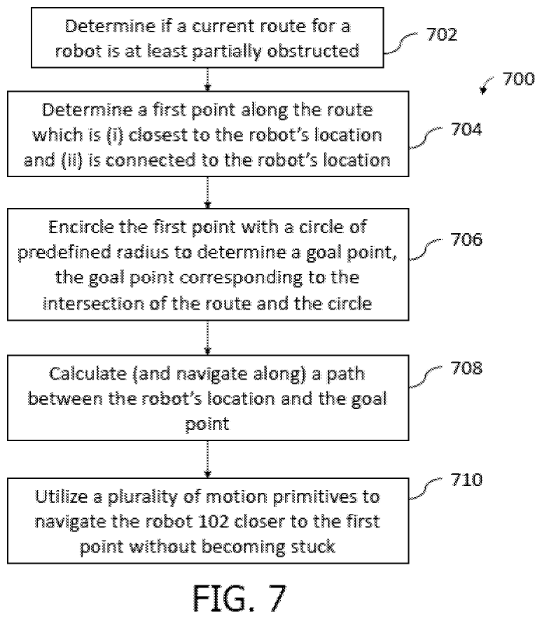

FIG. 7 is a process flow diagram illustrating a method 700 for avoiding an obstruction in a path of a robot while navigating the robot 102 back onto its original path as closely as possible, according to an exemplary embodiment. Steps of method 700 may be effectuated via the controller 118 executing instructions from a non-transitory computer readable memory 120.

Block 702 includes the controller 118 determining if a current route a robot 102 is navigating along is obstructed, either in whole or in part. Obstructions may be detected upon a pixel of the map containing both an object state encoding and a route state encoding, i.e., that the pixel includes both the route and a detected object at the same location. Although objects being directly on the route causes obstructions, in some instances objects may be adjacent to the route yet close enough to still require a diversion from the original trajectory. In some cases, such diversion may not always be possible without substantial rerouting. For instance, consider a robot 102 navigating down a hallway that is twice its width. If there is a person, pallet, shopping cart, or other object occupying half or more of the hallway or standing in the center of the hallway, the robot 102 would be unable to navigate around the object even if the object is not directly on the path.

Determining the path is obstructed may further include the controller 118 assigning dilation regions 506 around each object on the map. Next, the controller 118 may apply a flood fill algorithm onto (pseudo) randomly chosen pixels which are not objects nor within dilation regions 506. The flood fill algorithm would indicate the navigable pixels on the map, wherein pixels not connected via the flood fill algorithm to the pixel where the robot is located are considered unreachable. For instance, with reference to FIG. 5A, the flood fill algorithm would indicate that point 508 is potentially reachable due to the white pixels within the vertical hallway being connected to the robot 102 location via white pixels. Had another object 504 been placed in the vertical hallway between the two labeled objects 510, the white pixels within the hallway would not connect via a flood fill algorithm to the robot 102 position and are therefore determined to not be reachable. Reachable, as used herein, refers to the ability of a robot 102 to navigate to a point without collision, as opposed to navigable which means the robot 102 is able to be at the point without collisions such that a collision-free path is taken by the robot 102.

Block 704 includes the controller 118 determining a first point along the route closest to the obstruction which is also connected to the robot location. In some instances, the first point may also be the point closest to the obstruction along the route which is also connected to the robot location. For example, in FIG. 5A, a blockage due to an object 504 is detected. The first point 508 is chosen due to it being (i) within navigable space (white pixels), (ii) beyond the blockage yet as close to it as possible, and (iii) connected to the robot 102 location.

Block 706 includes the controller 118 determining a goal point by encircling the first point with a circle of a predefined radius (e.g., 1, 5, 15, etc. meters). The goal point is chosen based on the intersection of the circle with the earliest point along the route which is beyond the first point along the route. For example, as shown in FIG. 5C, the circle 514 is illustrated as intersecting the route 502 in three locations: one approximately where the robot 102 is, a second in the middle of an hallway, and a third to the left of the hallway. The point closest to the robot 102 is not beyond the blockage (i.e., is earlier along the route than the first point 508), thus assigning it as a goal point would be fruitless as the robot 102 is still blocked from continuing the route due to object 504. The third intersection point is later along the original route 502 than the second intersection, thus the second intersection point is preferred as it preserves more of the original route 502. In embodiments where the route 502 includes multiple switch-backs and/or loops, choosing the intersection earliest along the original route preserves more of the original route 502 than continuing along the later switchbacks.

Block 708 includes the controller 118 calculating a path between the robot location and the goal point. Since the robot 102 location and goal point are both connected, the controller 118 may generate a path without needing to do pixel-wise collision checks for each movement. Thus, the path between the robot 102 and the goal point may be readily calculated. Precise maneuvering close to objects is rarely a requirement at this stage as typically during rerouting task execution is paused until the robot 102 is able to resume its original task/route. For instance, robots which clean floors may not be cleaning floors while rerouting onto its original cleaning path, lessening the need for precise navigation nearby objects and improving the overall calculation speed.

Block 710 includes the controller 118 utilizing a plurality of motion primitives to navigate the robot 102 closer to the first point without becoming stuck. A motion primitive comprises a pre-calculated discrete maneuver the robot 102 could execute, wherein the kinematics (i.e., where the robot 102 is/was during the maneuver) are also pre-determined along with motor commands to effectuate such predetermined maneuvers. Motion primitives may be discretized in terms of their distance traveled, execution time, and by their turning amounts. For example, in a tricycle drive robot 102, there may be an array of motion primitives each corresponding to a 0.1 meter displacement of the robot at various angles of the central steering column (e.g., a 0° turn, a ±5° turn, a ±10° turn, etc.). By executing ten of these primitives sequentially, the robot 102 may follow a route of 1 meter. It is appreciated that the inclusion of more motion primitives enables more accurate maneuvering at the cost of additional computational complexity and memory use in determining optimal solutions. Furthermore, maneuvering the robot 102 from the goal point to the first point may also cause the robot 102 to travel close to objects, including the obstruction of the path, therefore requiring precise and optimized navigation. Each primitive evaluated in block 710 may be checked for collisions via method 600, however due to the robot 102 navigating nearby the object blocking its route many if not all possible maneuvers do not fall within conditions of blocks 608 and 612 and may require pixel-wise collision checking.

Stated another way, blocks 708 and 710 break down the rerouting problem into two stages once a valid first point is detected: (i) navigate the robot 102 closer to the first point (i.e., navigate to the goal point) using less precise navigation; and (ii) reroute onto the original path using a more precise and optimized motion planning. This method may advantageously reduce calculation time for the majority of the rerouting path in many situations, where precise navigation is often not necessary as tasks are typically paused during rerouting. Precise navigation is still utilized when the robot 102 is returning to its original path as this often causes the robot to move nearby objects as well as ensure the robot 102 is in the proper location to resume task performance.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for motion planning and replanning in a robotic navigation system, the method comprising:
producing, by a controller of the robotic navigation system, an environment map comprising a plurality of map pixels, wherein each map pixel encodes an occupancy state indicating whether an obstacle is present at a corresponding location;
computing, by the controller, a distance transform of the environment map to generate a distance transform map in which each non-obstacle map pixel stores a distance value representing a distance to a nearest obstacle pixel, and storing the distance transform map in a memory accessible to the controller;
defining a robot position as a pixel location in the distance transform map;
performing, by the controller, collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius R_{O} of a footprint of the robot, wherein R_{O} is the radius of a smallest circle enclosing the footprint of the robot;
navigating the robot toward a target position.

2. The method of claim 1, wherein computing the distance transform comprises applying a Euclidean distance transform algorithm that assigns to each non-obstacle pixel a distance value equal to the Euclidean distance to the nearest obstacle pixel, and wherein updating the distance transform map upon detection of a new obstacle comprises incrementally recomputing only those pixels whose stored distance values are affected by the new obstacle, without recomputing a full distance transform map.

3. The method of claim 1, wherein performing collision checks further comprises:
classifying the candidate pose as guaranteed in collision without further evaluation when the retrieved distance value is less than an inscribed radius R_{I} of the footprint of the robot, wherein R_{I} is the radius of a largest circle fully inscribed within the footprint of the robot; and
performing an orientation-dependent footprint evaluation for the candidate pose only when the retrieved distance value is greater than or equal to R_I and less than R_O.

4. The method of claim 1, further comprising:
generating offline a pre-computed library of navigation primitives and storing in the memory prior to deployment of the robot, each navigation primitive defined by a tuple comprising a steering parameter, an arc length, a resulting translational displacement of the robot, and a resulting heading change of the robot, wherein no navigation primitive produces a motion arc having a radius of curvature less than a minimum turning radius of the robot.

5. The method of claim 1, further comprising:
utilizing a pre-computed library of navigation primitives stored in the memory to navigate the robot toward the target position, wherein each navigation primitive defines a kinematically feasible discrete motion of the robot satisfying a minimum turning radius constraint of the robot, and wherein any navigation primitive whose associated candidate poses are classified as colliding is excluded from navigation;
calculating a planned path from the robot position to the target position;
navigating the robot along the planned path toward the target position;
determining a goal point by finding an intersection of the planned path with a circle centered at the target position and having a predefined radius, wherein the intersection point is set as the goal point to prevent the robot from entering a kinematic trap state at the target position; and
replanning the path upon detecting a change in the environment map, wherein replanning comprises: updating the distance transform map based on the detected change; redefining the robot position; performing updated collision checks using the updated distance transform map and a circumscribed radius R_O; and determining an updated collision-free path using the navigation primitives.

6. The method of claim 5, wherein the predefined radius of the circle used to determine the goal point is equal to a sum of the circumscribed radius R_O and a safety margin, and wherein the safety margin is determined based on at least one of: a statistical localization uncertainty of position estimate of the robot, or a minimum stopping distance of the robot at a current operating speed.

7. The method of claim 5, further comprising:
prior to replanning, performing a navigability connectivity check on the updated environment map to determine whether the robot position and the target position reside within a same contiguous navigable region; and
when the navigability connectivity check determines that the robot position and the target position do not reside within the same contiguous navigable region, at least one of: selecting an alternative target position that resides within the same contiguous navigable region as the robot position, or issuing a replanning failure notification to a user interface of the robotic navigation system.

8. A robotic navigation system comprising:
a memory storing computer readable instructions, a distance transform map, and a pre-computed library of navigation primitives; and
at least one processor configured to execute the computer readable instructions to:
produce an environment map comprising a plurality of map pixels, wherein each map pixel encodes an occupancy state indicating whether an obstacle is present at a corresponding location;
compute a distance transform of the environment map to generate the distance transform map in which each non-obstacle map pixel stores a distance value representing a distance to a nearest obstacle pixel, and store the distance transform map in the memory;
define a robot position as a pixel location in the distance transform map;
perform collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius R_O of a footprint of a robot controlled by the robotic navigation system, wherein R_O is the radius of a smallest circle enclosing the footprint of the robot;
navigate the robot toward a target position using the pre-computed library of navigation primitives, wherein each navigation primitive defines a kinematically feasible discrete motion of the robot satisfying a minimum turning radius constraint of the robot, and wherein any navigation primitive whose associated candidate poses are classified as colliding is excluded from navigation;
calculate a planned path from the robot position to the target position; and
navigate the robot along the planned path toward the target position;

9. The robotic navigation system of claim 8, wherein the at least one processor is further configured to compute the distance transform by applying a Euclidean distance transform algorithm that assigns to each non-obstacle pixel a distance value equal to the Euclidean distance to the nearest obstacle pixel, and to update the distance transform map incrementally upon detection of a new obstacle by recomputing only those pixels whose stored distance values are affected by the new obstacle.

10. The robotic navigation system of claim 8, wherein the at least one processor is further configured to perform collision checks by:
classifying the candidate pose as guaranteed in collision without further evaluation when the retrieved distance value is less than an inscribed radius R_I of the footprint of the robot, wherein R_I is the radius of a largest circle fully inscribed within the footprint of the robot; and
performing an orientation-dependent footprint evaluation for the candidate pose only when the retrieved distance value is greater than or equal to R_I and less than R_O.

11. The robotic navigation system of claim 8, wherein the pre-computed library of navigation primitives is stored in the memory prior to deployment of the robot, each navigation primitive defined by a tuple comprising a steering parameter, an arc length, a resulting translational displacement of the robot, and a resulting heading change of the robot, and wherein no navigation primitive produces a motion arc having a radius of curvature less than the minimum turning radius of the robot.

12. The robotic navigation system of claim 8, wherein the at least one processor is further configured to execute the computer readable instructions to:
determine a goal point by finding an intersection of the planned path with a circle centered at the target position and having a predefined radius, wherein the intersection point is set as the goal point to prevent the robot from entering a kinematic trap state at the target position; and
replan the path upon detecting a change in the environment map by: updating the distance transform map based on the detected change; redefining the robot position; performing updated collision checks using the updated distance transform map and the circumscribed radius R_O; and determining an updated collision-free path using the navigation primitives.

13. The robotic navigation system of claim 12, wherein the predefined radius of the circle used to determine the goal point is equal to a sum of the circumscribed radius R_O and a safety margin, and wherein the safety margin is determined based on at least one of: a statistical localization uncertainty of position estimate of the robot, or a minimum stopping distance of the robot at a current operating speed.

14. The robotic navigation system of claim 12, wherein the at least one processor is further configured to, prior to replanning, perform a navigability connectivity check on the updated environment map to determine whether the robot position and the target position reside within a same contiguous navigable region, and, when they do not, at least one of: select an alternative target position within the same contiguous navigable region as the robot position, or issue a replanning failure notification to a user interface of the robotic navigation system.

15. A non-transitory computer-readable medium storing instructions that, when executed by at least one processor of a robotic navigation system, cause the at least one processor to:
produce an environment map comprising a plurality of map pixels, wherein each map pixel encodes an occupancy state indicating whether an obstacle is present at a corresponding location;
compute a distance transform of the environment map to generate a distance transform map in which each non-obstacle map pixel stores a distance value representing a distance to a nearest obstacle pixel, and store the distance transform map in a memory of the robotic navigation system;
define a robot position as a pixel location in the distance transform map;
perform collision checks for candidate robot poses by, for each candidate pose: retrieving the distance value stored at the pixel location corresponding to the candidate pose from the distance transform map; and classifying the candidate pose as collision-free without further geometric evaluation when the retrieved distance value is greater than or equal to a circumscribed radius R_O of a footprint of a robot controlled by the robotic navigation system, wherein R_O is the radius of a smallest circle enclosing the footprint of the robot;
navigate the robot toward a target position using a pre-computed library of navigation primitives, wherein each navigation primitive defines a kinematically feasible discrete motion of the robot satisfying a minimum turning radius constraint of the robot, and wherein any navigation primitive whose associated candidate poses are classified as colliding is excluded from navigation;
calculate a planned path from the robot position to the target position; and
navigate the robot along the planned path toward the target position;

16. The non-transitory computer-readable medium of claim 15, wherein the instructions further cause the at least one processor to compute the distance transform by applying a Euclidean distance transform algorithm that assigns to each non-obstacle pixel a distance value equal to the Euclidean distance to the nearest obstacle pixel, and to update the distance transform map incrementally upon detection of a new obstacle by recomputing only those pixels whose stored distance values are affected by the new obstacle.

17. The non-transitory computer-readable medium of claim 15, wherein the instructions further cause the at least one processor to perform collision checks by:
classifying the candidate pose as guaranteed in collision without further evaluation when the retrieved distance value is less than an inscribed radius R_I of the footprint of the robot, wherein R_I is the radius of a largest circle fully inscribed within the footprint of the robot; and
performing an orientation-dependent footprint evaluation for the candidate pose only when the retrieved distance value is greater than or equal to R_I and less than R_O.

18. The non-transitory computer-readable medium of claim 15, wherein the pre-computed library of navigation primitives is generated offline and stored in the memory prior to deployment of the robot, each navigation primitive defined by a tuple comprising a steering parameter, an arc length, a resulting translational displacement of the robot, and a resulting heading change of the robot, and wherein no navigation primitive produces a motion arc having a radius of curvature less than the minimum turning radius of the robot.

19. The non-transitory computer-readable medium of claim 15, wherein the instructions further cause the at least one processor to:
determine a goal point by finding an intersection of the planned path with a circle centered at the target position and having a predefined radius, wherein the intersection point is set as the goal point to prevent the robot from entering a kinematic trap state at the target position; and
replan the path upon detecting a change in the environment map by: updating the distance transform map based on the detected change; redefining the robot position; performing updated collision checks using the updated distance transform map and the circumscribed radius R_O; and determining an updated collision-free path using the navigation primitives.

20. The non-transitory computer-readable medium of claim 19, wherein the predefined radius of the circle used to determine the goal point is equal to a sum of the circumscribed radius R_O and a safety margin, and wherein the safety margin is determined based on at least one of: a statistical localization uncertainty of position estimate of the robot, or a minimum stopping distance of the robot at a current operating speed.
